(19) United States
(12) Patent Application Publication
(10) Pub. No.: US 2026/0155962 A1
(43) Pub. Date: Jun. 4, 2026

(54) ELECTRONIC DEVICE AND METHOD FOR ACTIVATING A VEHICLE FEATURE ON DEMAND (FOD) SERVICE AND AN FOD SERVER AND METHOD FOR SUPPORTING A VEHICLE FOD SERVICE

(71) Applicants: HYUNDAI MOTOR COMPANY, Seoul (KR); KIA CORPORATION, Seoul (KR)

(72) Inventors: Yewon Kim, Hwaseong-si (KR); Jiyong Han, Hwaseong-si (KR); Hyemin Nam, Hwaseong-si (KR)

(73) Assignees: HYUNDAI MOTOR COMPANY, Seoul (KR); KIA CORPORATION, Seoul (KR)

(21) Appl. No.: 19/241,868

(22) Filed: Jun. 18, 2025

(30) Foreign Application Priority Data
Dec. 2, 2024 (KR) 10-2024-0176313

(51) Int. Cl. H04L 9/08; H04L 9/32

(52) U.S. Cl. CPC H04L 9/0852; H04L 9/088; H04L 9/3247

(57) ABSTRACT

A method for activating a vehicle feature on demand (FoD) service by an electronic device includes requesting information related to the FoD service from an FoD server. The method further includes receiving information related to the FoD service for a vehicle from the FoD server. The method further includes verifying an electronic signature included in the received information related to the FoD service for the vehicle. The method further includes decrypting information for activating the FoD service included in the received information related to the FoD service for the vehicle. The method further includes activating the FoD service when the electronic signature is successfully verified and the information for activating the FoD service is successfully decrypted. The method further includes transmitting a result of the activated FoD service to the FoD server.

### CROSS-REFERENCE TO RELATED APPLICATION

This application claims priority to and the benefit of Korean Patent Application No. 10-2024-0176313, filed on Dec. 2, 2024, the entire contents of which are incorporated herein by reference.

### TECHNICAL FIELD

The present disclosure relates to a method of activating a vehicle feature on demand (FoD) service and relates to an electronic device and an FoD server to which the method is applied. More particularly, the present disclosure relates to a method of activating a vehicle FoD service to which an encryption algorithm is applied, and the present disclosure also relates to an electronic device and an FoD server to which the method is applied.

### BACKGROUND

Feature on demand (FoD) is an optional subscription service for selectively purchasing a feature of a vehicle using wireless communication technology. According to the related art, before a car leaves a factory, a customer chooses functions that he or she wants to use, and the chosen features are installed in the car. However, the use of an FoD service enables a customer to selectively purchase and add desired software functions in accordance with his or her circumstance even after a vehicle leaves the factory.

The FoD service is utilized in a variety of areas, such as a navigation system, a parking distance warning (PDW) system, a surround viewing monitor (SVM) system, a parking collision-avoidance assist (PCA) system, a remote smart parking assist (RSPA) system, and an advanced driver assistance system (ADAS). These systems are not permanent and may be continuously developed. Accordingly, users may choose and subscribe to desired options in accordance with their necessities.

An FoD service can be implemented by software and accessed through a wireless network, and thus there is a high risk of being hacked. To protect software from hacking, encryption algorithms are used. However, the safety of encryption algorithms is being significantly affected by the development of quantum computing technology. For example, Grover's algorithm, which is a quantum algorithm, is a serious threat to the security of symmetric encryption algorithms. Grover's algorithm can reduce the time complexity of searching for a specific function to the square root of the time complexity, which has the effect of halving the key space of a symmetric-key cipher. Shor's algorithm is another quantum algorithm that can solve prime factorization problems and discrete algebra problems in polynomial time, which breaks the fundamental security of currently popular public-key cryptosystems like Rivest-Shamir-Adleman (RSA) and the elliptic curve digital signature algorithm (ECDSA). A solution to this problem is the development of quantum-resistant cryptography which is an asymmetric-key cryptography algorithm based on a quantum computer, and related research is underway. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure is directed to providing a method of activating a vehicle feature on demand (FoD) service to which an encryption algorithm is applied. The present disclosure is directed to providing an electronic device and an FoD server to which the method is applied.

The present disclosure is also directed to providing a method of activating a vehicle FoD service that is difficult to hack even using quantum computing technology. The present disclosure is directed to providing an electronic device and an FoD server to which the method is applied.

The present disclosure is also directed to providing a method of activating an FoD service for a vehicle both before and after an encryption algorithm in the vehicle is changed to an algorithm to which a quantum-resistant cipher is applied. The present disclosure is directed to providing an electronic device and an FoD server to which the method is applied.

Technical objects to be achieved by the present disclosure are not limited to those described above, and other objects which have not been described should be clearly understood from the following description by those of ordinary skill in the art.

According to an aspect of the present disclosure, a method includes requesting information related to an FoD service from an FoD server. The method further includes receiving information related to the FoD service for a vehicle from the FoD server. The method further includes verifying an electronic signature included in the received information related to the FoD service for the vehicle. The method further includes decrypting information for activating the FoD service included in the received information related to the FoD service for the vehicle. The method further includes activating the FoD service when the electronic signature is successfully verified and the decryption of the information for activating the FoD service is successfully decrypted. The method further includes transmitting a result of the activated FoD service to the FoD server. The information related to the FoD service for the vehicle includes the information for activating the FoD service and the electronic signature, and an encryption algorithm is applied to the information for activating the FoD service and the electronic signature based on information on the vehicle.

The information on the vehicle may be information on a date on which the vehicle was released, and when the vehicle is released after a specific date, the encryption algorithm may be an algorithm to which post-quantum cryptography (PQC) is applied.

The information on the vehicle may be information on a date on which the vehicle was released, and when the vehicle is released before a specific date, a plurality of encryption algorithms may be separately applied to the information for activating the FoD service and the electronic signature.

The method may further include transmitting information on firmware or software applied to the vehicle in relation to the FoD service, and the information on the vehicle may be information on the encryption algorithm applied to the vehicle.

An encryption algorithm applied to the information for activating the FoD service may be a symmetric-key encryption algorithm, and an encryption algorithm applied to the electronic signature may be an asymmetric-key encryption algorithm.

According to another aspect of the present disclosure, a method of supporting a vehicle FoD service by an FoD server includes receiving a request for information related to the FoD service from a vehicle. The method further includes generating information that is related to an FoD service for the vehicle and includes information for activating the FoD service and an electronic signature. The method further includes transmitting the information related to the FoD service for the vehicle to the vehicle. An encryption algorithm is applied to the information for activating the FoD service and the electronic signature based on information on the vehicle.

The information on the vehicle may be information on a date on which the vehicle was released, and when the vehicle is released after a specific date, the encryption algorithm may be an algorithm to which PQC is applied.

The information on the vehicle may be information on a date on which the vehicle was released, and when the vehicle is released before a specific date, a plurality of encryption algorithms may be separately applied to the information for activating the FoD service and the electronic signature.

The method may further include receiving information on firmware or software applied to the vehicle in relation to the FoD service from the vehicle, and the information on the vehicle may be information on the encryption algorithm applied to the vehicle.

An encryption algorithm applied to the information for activating the FoD service may be a symmetric-key encryption algorithm, and an encryption algorithm applied to the electronic signature may be an asymmetric-key encryption algorithm.

According to another aspect of the present disclosure, an electronic device for activating a vehicle FoD service, the electronic device includes a communication module, a memory, and a processor. The processor is configured to request information related to an FoD service from an FoD server. The processor is further configured to receive information related to the FoD service for a vehicle from the FoD server. The processor is further configured to verify an electronic signature included in the received information related to the FoD service for the vehicle, and decrypt information for activating the FoD service included in the received information related to the FoD service for the vehicle. The processor is further configured to activate the FoD service when the electronic signature is successfully verified and the information for activating the FoD service is successfully decrypted. In other words, the processor is configured to activate the FoD service based on the electronic signature being verified and based on the information for activating the FoD service being successfully decrypted. The processor is further configured to transmit a result of the activated FoD service to the FoD server. The information related to the FoD service for the vehicle includes the information for activating the FoD service and the electronic signature. An encryption algorithm is applied to the information for activating the FoD service and the electronic signature based on information on the vehicle.

The information on the vehicle may be information on a date on which the vehicle was released, and when the vehicle is released after a specific date, the encryption algorithm may be an algorithm to which PQC is applied.

The information on the vehicle may be information on a date on which the vehicle was released, and when the vehicle is released before a specific date, a plurality of encryption algorithms may be separately applied to the information for activating the FoD service and the electronic signature.

The processor may further transmit information on firmware or software applied to the vehicle in relation to the FoD service, and the information on the vehicle may be information on the encryption algorithm applied to the vehicle.

An encryption algorithm applied to the information for activating the FoD service may be a symmetric-key encryption algorithm, and an encryption algorithm applied to the electronic signature may be an asymmetric-key encryption algorithm.

According to another aspect of the present disclosure, an FoD server for supporting a vehicle FoD service includes a communication module, a memory, and a processor. The processor is configured to receive a request for information related to an FoD service from a vehicle. The processor is further configured to generate information that is related to the FoD service for the vehicle and includes information for activating the FoD service and an electronic signature. The processor is further configured to transmit the information related to the FoD service for the vehicle to the vehicle. An encryption algorithm is applied to the information for activating the FoD service and the electronic signature based on information on the vehicle.

The information on the vehicle may be information on a date on which the vehicle is released, and when the vehicle is released after a specific date, the encryption algorithm may be an algorithm to which PQC is applied.

The information on the vehicle may be information on a date on which the vehicle is released, and when the vehicle is released before a specific date, a plurality of encryption algorithms may be separately applied to the information for activating the FoD service and the electronic signature.

The processor may further receive information on firmware or software applied to the vehicle in relation to the FoD service from the vehicle, and the information on the vehicle may be information on the encryption algorithm applied to the vehicle.

An encryption algorithm applied to the information for activating the FoD service may be a symmetric-key encryption algorithm, and an encryption algorithm applied to the electronic signature may be an asymmetric-key encryption algorithm.

### BRIEF DESCRIPTION OF THE DRAWINGS

The above and other objects, features, and advantages of the present disclosure should become more apparent to those of ordinary skill in the art by describing implementations thereof in detail with reference to the accompanying drawings, in which:

FIG. 1 is a diagram illustrating a system for providing a vehicle feature on demand (FoD) service according to an implementation of the present disclosure;

FIG. 2 is a diagram showing information generated by an FoD server to activate an in-vehicle FoD service according to an implementation of the present disclosure;

FIG. 3 is a flowchart for an FoD server and an in-vehicle electronic device to activate a vehicle FoD service according to a first implementation of the present disclosure;

FIG. 4 is a flowchart for an FoD server and an in-vehicle electronic device to activate a vehicle FoD service according to a second implementation of the present disclosure;

FIG. 5 is a flowchart for an FoD server and an in-vehicle electronic device to activate a vehicle FoD service according to a third implementation of the present disclosure;

FIG. 6 is a flowchart for an in-vehicle electronic device to activate a vehicle FoD service according to an implementation of the present disclosure;

FIG. 7 is a flowchart for an FoD server to support the activation of a vehicle FoD service according to an implementation of the present disclosure;

FIG. 8 is a block diagram of an in-vehicle electronic device according to an implementation of the present disclosure; and

FIG. 9 is a block diagram of an FoD server according to an implementation of the present disclosure.

### DETAILED DESCRIPTION

Hereinafter, implementations of the present disclosure are described in detail with reference to the accompanying drawings.

However, the technical spirit of the present disclosure is not limited to the described implementations but may be implemented in various different forms. Within the scope of the technical spirit of the present disclosure, one or more components may be selectively combined or displaced and used between the implementations.

Further, terms (including technical and scientific terms) used in the implementations of the present disclosure may be interpreted in a way that is generally understood by those of ordinary skill in the art to which the present disclosure pertains, unless clearly and specifically defined and described otherwise. Commonly used terms, such as terms defined in dictionaries, may be interpreted in consideration of the contextual meaning of the relevant technology.

In addition, the terms used the present disclosure are intended to describe the implementations and are not intended to limit the present disclosure.

In the present disclosure, singular forms may also include plural forms unless otherwise specified in the phrase, and “at least one (or one or more) of A, B, and C” and “at least one (or one or more) of A, B, or C” may include one or more of all combinations of A, B, and C.

In describing components of the present disclosure, terms, such as “first,” “second,” “A,” “B,” “(a),” “(b),” and the like, may be used.

These terms are intended to distinguish corresponding components from others, and the nature, sequence, order, or the like of the components is not limited by the terms.

When a component is described as being “connected to,” “combined with,” or “coupled to” another component, the component may be not only directly connected to, combined with, or coupled to the other component but also connected to, combined with, or coupled to the other component with an intervening component interposed therebetween.

In addition, when a component is described as being formed or disposed “on (above) or under (below)” another component, the two components may be directly in contact with each other, or an intervening component may be formed or disposed therebetween. Also, when a component is expressed as “on (above) or under (below)” another component, the component may be in an upper or lower direction from the other component. When a controller, module, unit, component, device, element, or the like of the present disclosure is described as having a purpose or performing an operation, function, or the like, the controller, module, unit, component, device, element, or the like should be considered herein as being “configured to” meet that purpose or to perform that operation or function. Each controller, module, unit, component, device, element, and the like may separately embody or be included with a processor and a memory, such as a non-transitory computer readable media, as part of the apparatus.

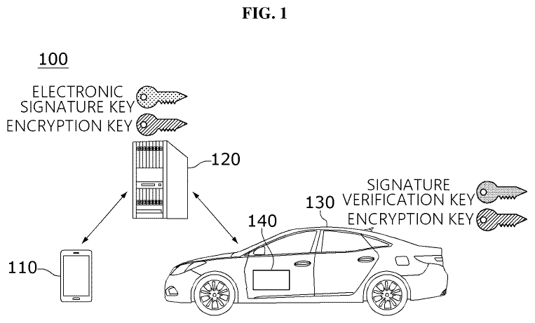

FIG. 1 is a diagram illustrating a system for providing a vehicle feature on demand (FoD) service according to an implementation of the present disclosure.

Referring to FIG. 1, a system 100 for providing a vehicle FoD service may include a vehicle 130 and an FoD server 120. According to an implementation, the system 100 for providing a vehicle FoD service may further include an electronic device 110 that may be used by a user. More specifically, the vehicle 130 may include an electronic device 140 for providing an FoD service, and the in-vehicle electronic device 140 may be included in the system 100 for providing a vehicle FoD service.

To receive an FoD service in the vehicle 130, a user may purchase or subscribe to the FoD service first. In this case, the user may use the electronic device 110. For example, the user may purchase or subscribe to the FoD service on the web or using an application (app). When the user purchases or subscribes to the FoD service on the web or using the app, related information is transmitted to the FoD server 120. After checking data transmitted by the user, the FoD server 120 may generate data for providing the FoD service, i.e., information related to the vehicle FoD service, and may transmit the data to the in-vehicle electronic device 140. The FoD server 120 may use an electronic signature key and an encryption key for the integrity and confidentiality of information to be transmitted. The in-vehicle electronic device 140 may check the received data and activate the FoD service. The in-vehicle electronic device 140 may use a signature verification key (or an electronic signature verification key) and the encryption key to check the received data. The in-vehicle electronic device 140 may decrypt the received data, may verify the electronic signature, and then may activate the FoD service only when the electronic signature is valid. Subsequently, the in-vehicle electronic device 140 may transmit an FoD service activation result including information about whether the in-vehicle FoD service is activated and the like to the FoD server 120. The FoD server 120 may transmit the received FoD service activation result to the electronic device 110 of the user.

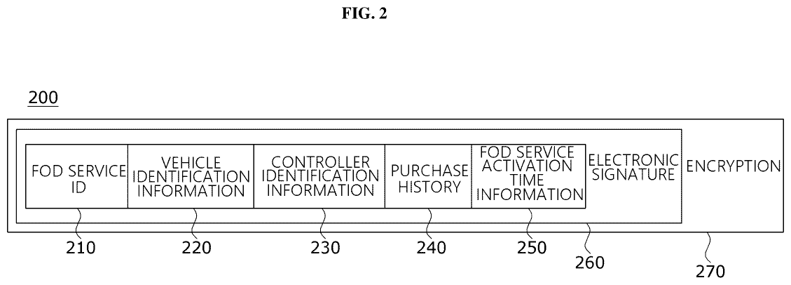

FIG. 2 is a diagram showing information generated by an FoD server to activate an in-vehicle FoD service according to an implementation of the present disclosure.

Referring to FIG. 2, information 200 for activating an in-vehicle FoD service generated by an FoD server may include an FoD service identifier (ID) 210, vehicle identification information 220, controller identification information 230, a purchase history 240, and FoD service activation time information 250. Also, an electronic signature 260 may be added, and the information 200 for activating an in-vehicle FoD service and the electronic signature 260 may be encrypted (i.e., processed by encryption 270).

Specifically, the FoD service ID 210 may be an ID of the FoD service. In other words, there may be a variety of FoD services, and each FoD service may have a unique ID for distinction. An in-vehicle electronic device may check the FoD service ID 210 to determine an FoD service to be activated. The vehicle identification information 220 may be identification information of a vehicle that has purchased or subscribed to the FoD service. For example, information on a type of vehicle may be included in the vehicle identification information 220 such that the in-vehicle electronic device may determine whether received information is activatable in the type of vehicle. The controller identification information 230 may present identification information of a controller (or an electronic control device) by which the FoD service to be activated will be performed, and the purchase history 240 may include information on a date on which the user purchases the FoD service and the like. Also, the FoD service activation time information 250 may include information on an expiration date of the FoD service and the like. The electronic signature 260 may demonstrate that the electronic signature 260 has been generated by the FoD server. The encryption 270 demonstrates that the information 200 for activating the in-vehicle FoD service has been encrypted to prevent details thereof from being leaked even when the information 200 leaks. According to an implementation, an asymmetric key may be used for the electronic signature 260, and a symmetric key may be used for the encryption 270.

According to an implementation, the information 200 for activating the in-vehicle FoD service may be determined by a manufacturer that provides the FoD service.

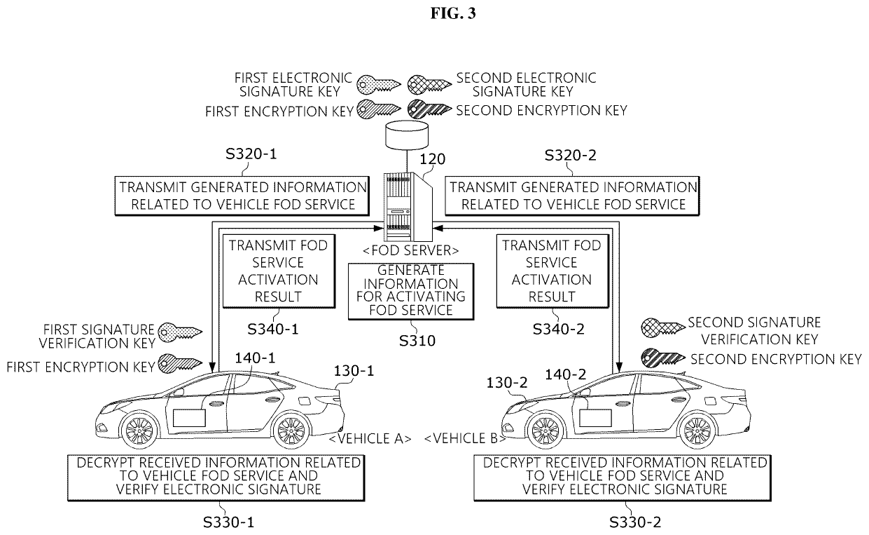

FIG. 3 is a flowchart for an FoD server and an in-vehicle electronic device to activate a vehicle FoD service according to a first implementation of the present disclosure.

The first implementation of the present disclosure is an implementation in which an FoD server determines information on encryption technology stored in a vehicle using information on the vehicle.

Referring to FIG. 3, a vehicle A 130-1 and a vehicle B 130-2 may be vehicles that want to purchase or subscribe to an FoD service. In other words, users of the vehicle A 130-1 and the vehicle B 130-2 may have purchased or subscribed to the FoD service. The vehicles do not influence each other and may separately operate in conjunction with the FoD server 120.

According to an implementation, the vehicle A 130-1 and the vehicle B 130-2 may be distinguished based on vehicle information, which may be, for example, the date of manufacturing. As an example, vehicle A 130-1 may be manufactured before a specific date, and vehicle B 130-2 may be manufactured after the specific date. The specific date may be a time point when quantum computing technology is applied.

First, a flowchart for activating an FoD service of the vehicle A 130-1 is described below.

When the user of the vehicle A 130-1 purchases or subscribes to the FoD service, information related to the FoD service may be requested from the FoD server 120. The FoD server 120 may check information on the vehicle A 130-1 from the information related to the FoD service, which is transmitted when the user purchases or subscribes to the FoD service. The FoD server 120 may generate information for activating the FoD service based on the information on vehicle A 130-1 (S310). Because the vehicle A 130-1 is a vehicle manufactured before quantum computing technology is applied, the FoD server 120 may generate information for activating the FoD service using a first electronic signature key and a first encryption key. In one example, the first electronic signature key and the first encryption key may be an electronic signature key and an encryption key to which encryption technology other than post-quantum cryptography (PQC) is applied. For example, the first electronic signature may correspond to Rivest-Shamir-Adleman (RSA) or the elliptic curve digital signature algorithm (ECDSA), and the first encryption key may correspond to the advanced encryption standard (AES).

The FoD server 120 may transmit the generated information related to the vehicle FoD service (S320-1). In one example, the FoD server 120 may transmit the information to an in-vehicle electronic device 140-1 using wireless communication.

The in-vehicle electronic device 140-1 may decrypt the received information related to the vehicle FoD service and may verify the electronic signature (S330-1). When the received information related to the vehicle FoD service is determined to be valid, the in-vehicle electronic device 140-1 may activate the FoD service and may transmit the result to the FoD server 120 (S340-1).

A flowchart for activating an FoD service of vehicle B 130-2 is described below.

When the user of vehicle B 130-2 purchases or subscribes to the FoD service, information related to the FoD service may be requested from the FoD server 120. The FoD server 120 may check information on the vehicle B 130-2 from the information related to the FoD service, which is transmitted when the user purchases or subscribes to the FoD service. The FoD server 120 may generate information for activating the FoD service based on the information on vehicle B 130-2 (S310). Because the vehicle B 130-2 is a vehicle manufactured after quantum computing technology is applied, the FoD server 120 may generate information for activating the FoD service using a second electronic signature key and a second encryption key. In one example, the second electronic signature key and the second encryption key may be an electronic signature key and an encryption key to which PQC is applied. For example, the second electronic signature key may be a PQC electronic signature key, and the second encryption key may be a PQC encryption key.

The FoD server 120 may transmit the generated information related to the vehicle FoD service to an in-vehicle electronic device 140-2 (S320-2). To this end, the FoD server 120 may utilize wireless communication.

The in-vehicle electronic device 140-2 may decrypt the received information related to the vehicle FoD service and may verify the electronic signature (S330-2). The in-vehicle electronic device 140-2 may decrypt the information related to the vehicle FoD service using the PQC encryption key corresponding to the second encryption key and may verify the electronic signature using the PQC electronic signature verification key corresponding to the second electronic signature key. When the received information related to the vehicle FoD service is determined to be valid, the in-vehicle electronic device 140-2 may activate the FoD service and may transmit the result to the FoD server 120 (S340-2).

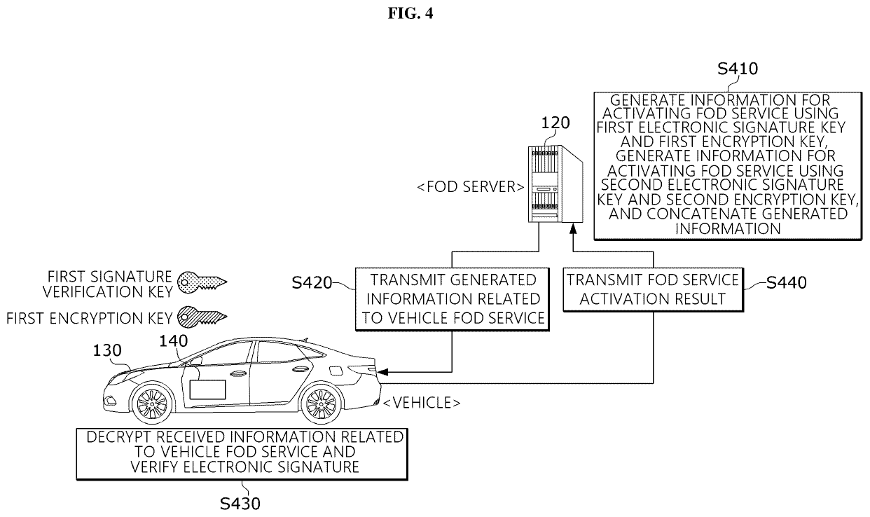

FIG. 4 is a flowchart for an FoD server and an in-vehicle electronic device to activate a vehicle FoD service according to a second implementation of the present disclosure.

Referring to FIG. 4, a vehicle 130 may be a vehicle for which an FoD service has been purchased or subscribed to. In other words, a user of the vehicle 130 may have purchased or subscribed to the FoD service. The manufacturing date of the vehicle 130 is fixed, but software and/or firmware in the vehicle 130 is updatable. Accordingly, an encryption technology stored in the vehicle 130 may differ from an encryption technology of the date when the vehicle 130 is manufactured and released. In this case, information on the encryption technology stored in the vehicle 130 may be transmitted to an FoD server 120 as vehicle information. However, the information on the encryption technology stored in the vehicle 130 may not be transmitted for security reasons, in which case the FoD server 120 is not aware of the information. The second implementation of the present disclosure shows an example of activating a vehicle FoD service when the FoD server 120 is not aware of information on an encryption technology stored in a vehicle. More specifically, this is an implementation in which the vehicle 130 is manufactured before quantum computing technology is applied but the FoD server 120 that is not aware of whether software and/or firmware has been updated supports activation of a vehicle FoD service.

According to an implementation, when the user of the vehicle 130 purchases or subscribes to an FoD service, the FoD server 120 may receive information related to the FoD service. The FoD server 120 may check information on the vehicle 130 from the information related to the FoD service, which is transmitted when the user purchases or subscribes to the FoD service. When the vehicle 130 is manufactured after a specific date, the FoD server 120 may generate all information for activating an FoD service using a second electronic signature key and a second encryption key. However, when the vehicle 130 is manufactured before the specific date, the FoD server 120 is not aware of information on an encryption technology stored in the vehicle 130, may generate information for activating the FoD service using a first electronic signature key and a first encryption key, may generate information for activating the FoD service using a second electronic signature key and a second encryption key, and then may concatenate the generated information (S410). In one example, the first electronic signature key and the first encryption key may be an electronic signature key and an encryption key to which an encryption technology other than PQC is applied. For example, the first electronic signature may correspond to RSA or the ECDSA, and the first encryption key may correspond to the AES. The second electronic signature key and the second encryption key may respectively be an electronic signature key and an encryption key to which PQC is applied. For example, the second electronic signature may be a PQC electronic signature key, and the second encryption key may be a PQC encryption key.

The FoD server 120 may transmit the generated information related to the vehicle FoD service (S420). In one example, the FoD server 120 may transmit the information to an in-vehicle electronic device 140 using wireless communication.

The in-vehicle electronic device 140 may decrypt the received information related to the FoD service and may verify the electronic signature (S430). The in-vehicle electronic device 140 may decrypt the received information using the stored encryption technology and may verify the electronic signature. In other words, when the software and/or firmware is updated to store an algorithm to which PQC is applied, the in-vehicle electronic device 140 may verify and decrypt the electronic signature using a second electronic signature verification key and the second encryption key. When the software and/or firmware is not updated, the in-vehicle electronic device 140 may verify and decrypt the electronic signature using a first electronic signature verification key and the first encryption key. When the received information related to the vehicle FoD service is determined to be valid, the in-vehicle electronic device 140 may activate the FoD service and transmit the result to the FoD server 120 (S440).

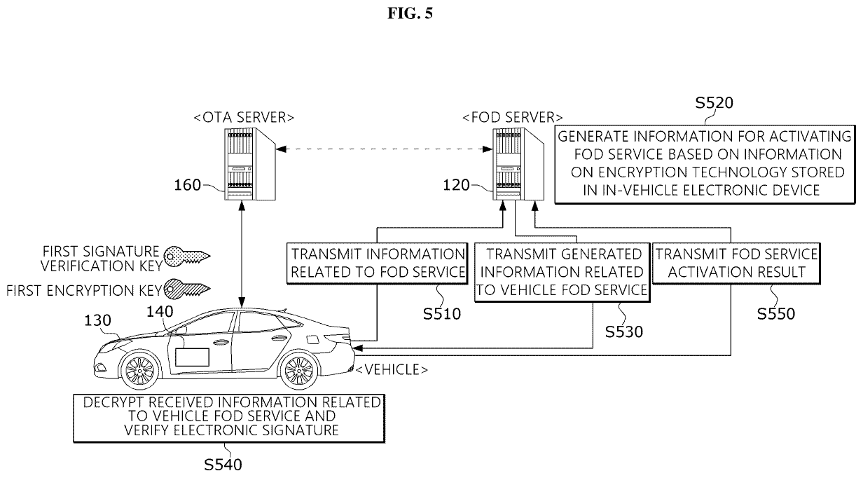

FIG. 5 is a flowchart for an FoD server and an in-vehicle electronic device to activate a vehicle FoD service according to a third implementation of the present disclosure.

Referring to FIG. 5, a user of a vehicle 130 may have purchased or subscribed to an FoD service, and thus the vehicle 130 may be a vehicle for which the FoD service will be purchased or subscribed to. As described above, because the manufacturing date of the vehicle 130 is fixed but software and/or firmware in the vehicle 130 is updatable, an encryption technology stored in the vehicle 130 may differ from an encryption technology of the date when the vehicle 130 was manufactured and released. The third implementation of the present disclosure shows an example in which the FoD server 120 is aware of information on an encryption technology stored in a vehicle. For example, the third implementation may correspond to the case where a server for updating in-vehicle software or firmware and the FoD server 120 are run by the same manufacturer, and thus the third implementation may share relevant information by transmitting and receiving the relevant information or the case of transmitting information on an encryption technology stored in a vehicle to the FoD server 120. It is described that information on an encryption technology stored in a vehicle is transmitted, but the case where version information of an encryption technology is included in version information of the software or firmware may also correspond to the present implementation.

According to an implementation, when the user of the vehicle 130 purchases or subscribes to an FoD service, the FoD server 120 may receive information related to the FoD service (S510). The information related to the FoD service may include information on an encryption technology stored in the in-vehicle electronic device 140. Alternatively, since an over-the-air (OTA) server 160 that manages updates of the software or firmware of the in-vehicle electronic device 140, and the FoD server 120 may share vehicle information, the OTA server 160 may directly transmit information on the encryption technology stored in the in-vehicle electronic device 140 to the FoD server 120. According to an implementation, the OTA server 160 and the FoD server 120 may share vehicle information at any time point. Alternatively, the OTA server 160 and the FoD server 120 may share vehicle information at a time point when the in-vehicle electronic device 140 requests information related to the FoD service.

The FoD server 120 may generate information for activating the FoD service based on the information on the encryption technology stored in the in-vehicle electronic device 140 (S520). For example, when the encryption technology stored in the in-vehicle electronic device 140 is not quantum computing technology, the FoD server 120 may generate information for activating the FoD service using the first electronic signature key and the first encryption key. When the encryption technology is quantum computing technology, the FoD server 120 may generate information for activating the FoD service using the second electronic signature key and the second encryption key (S520). Like in the foregoing implementation, the first electronic signature key may correspond to RSA or the ECDSA, and the first encryption key may correspond to the AES. Also, the second electronic signature key may be a PQC electronic signature key, and the second encryption key may be a PQC encryption key.

The FoD server 120 may transmit the generated information related to the vehicle FoD service (S530). The in-vehicle electronic device 140 may decrypt the received information related to the vehicle FoD service and may verify the electronic signature (S540). When the received information related to the vehicle FoD service is determined to be valid, the in-vehicle electronic device 140 may activate the FoD service and transmit the result to the FoD server 120 (S550).

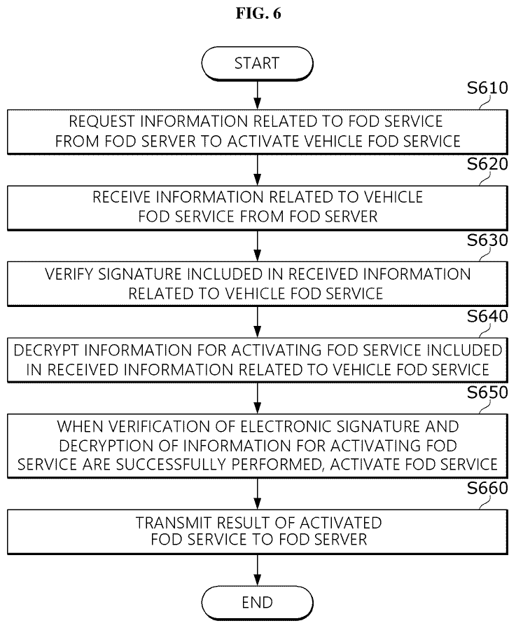

FIG. 6 is a flowchart for an in-vehicle electronic device to activate a vehicle FoD service according to an implementation of the present disclosure.

Referring to FIG. 6, an in-vehicle electronic device may request information related to an FoD service from an FoD server to activate the vehicle FoD service (S610). Instead, when a user purchases or subscribes to the vehicle FoD service using an electronic device, information related to the FoD service may be requested from the FoD server. Otherwise, when the user purchases or subscribes to the vehicle FoD service using an electronic device, the in-vehicle electronic device may receive related information from the electronic device of the user and request information related to the FoD service from the FoD server.

The in-vehicle electronic device may receive the information related to the vehicle FoD service from the FoD server (S620). According to an implementation, the information related to the vehicle FoD service may be encrypted for confidentiality and transmitted.

The in-vehicle electronic device may verify an electronic signature included in the received information related to the vehicle FoD service (S630). In one example, the in-vehicle electronic device may decrypt the electronic signature first.

The in-vehicle electronic device may decrypt information for activating the FoD service included in the received information related to the FoD service (S640). The information related to the vehicle FoD service may include the information for activating the FoD service and the electronic signature. An encryption algorithm may be applied to the information for activating the FoD service and the electronic signature based on vehicle information, and the vehicle information may be information on a date on which the vehicle was released. For example, when the vehicle was released after a specific date, the encryption algorithm may be an algorithm to which PQC is applied. In this case, a PQC signature verification key may be used to verify the electronic signature, and a PQC encryption key may be used to decrypt the information related to the vehicle FoD service. When the vehicle was released before a specific date, RSA, the ECDSA, or the AES may be used as the encryption algorithm. Specifically, the AES may be used to decrypt the information related to the vehicle FoD service, and RSA or the ECDSA may be used to verify the electronic signature. According to an implementation, an asymmetric-key encryption algorithm may be used as an encryption algorithm related to the electronic signature, and a symmetric-key algorithm may be used as an encryption algorithm for encrypting or decrypting information.

When the verification of the electronic signature and the decryption of the information for activating the FoD service are successfully performed, the in-vehicle electronic device may activate the FoD service (S650).

The in-vehicle electronic device may transmit the result of the activated FoD service to the FoD server (S660).

According to an implementation, the in-vehicle electronic device may update the encryption algorithms. Upon a software or/and firmware update, the encryption algorithm may be updated. The encryption algorithm stored in the in-vehicle electronic device may or may not be known to the FoD server. According to an implementation, when the FoD server is not aware of the encryption algorithm stored in the in-vehicle electronic device, the FoD server may transmit information related to the vehicle FoD service to which a plurality of encryption algorithms is applied. According to another implementation, the in-vehicle electronic device may transmit information on the stored encryption algorithm to the FoD server, and the FoD server may transmit information related to the vehicle FoD service to which the encryption algorithm suited to the vehicle is applied.

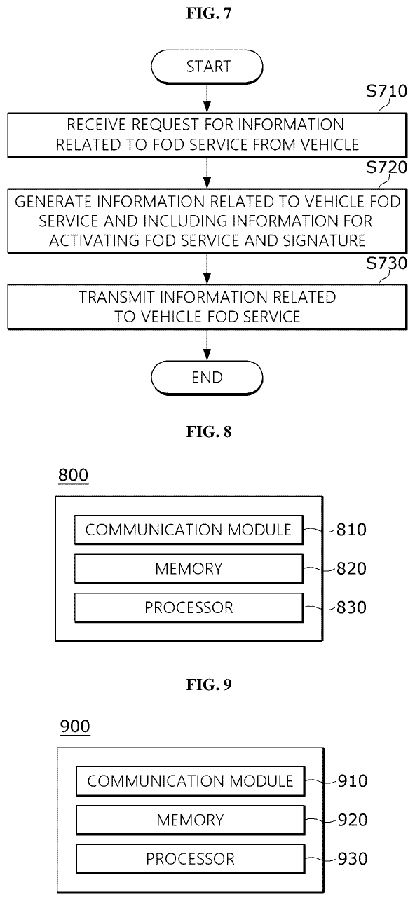

FIG. 7 is a flowchart for an FoD server to support the activation of a vehicle FoD service according to an implementation of the present disclosure.

Referring to FIG. 7, an FoD server may receive a request for information related to an FoD service from a vehicle to support the activation of the vehicle FoD service (S710).

The FoD server may generate information that is related to the vehicle FoD service and includes information for activating an FoD service and an electronic signature (S720). An encryption algorithm may be applied to the information for activating the FoD service and the electronic signature based on vehicle information. The vehicle information may include information on an encryption algorithm stored in an in-vehicle electronic device. However, when the FoD server is not aware of the encryption algorithm stored in the in-vehicle electronic device, the FoD server may generate and transmit information related to the vehicle FoD service to which a plurality of encryption algorithms is applied. The information related to the vehicle FoD service to which the plurality of encryption algorithms is applied may be concatenated with each other. An encryption algorithm applied to the electronic signature may differ from an encryption algorithm applied for encryption. For example, an asymmetric-key algorithm may be an encryption algorithm applied to the electronic signature, and a symmetric-key algorithm may be an encryption algorithm applied for encryption. The asymmetric-key algorithm may be RSA, the ECDSA, or a PQC algorithm, and the symmetric-key algorithm may be the AES or a PQC algorithm. The PQC algorithm may be an algorithm to which quantum computing technology is applied, and the others may be algorithms other than quantum computing technology.

The FoD server may transmit the information related to the vehicle FoD service to the vehicle (S730).

FIG. 8 is a block diagram of an in-vehicle electronic device according to an implementation of the present disclosure.

Referring to FIG. 8, an in-vehicle electronic device 800 may include a communication module 810, a memory 820, and a processor 830.

The communication module 810 may transmit and receive data to and from other elements in the in-vehicle electronic device 800 and external devices. The communication module 810 may be controlled by the processor 830. For example, the communication module 810 may be controlled by the processor 830 to transmit data to an FoD server or receive data from the FoD server.

The memory 820 may store data required by the in-vehicle electronic device 800. For example, the memory 820 may store data required for performing an encryption technology and an FoD service. The data required for performing an FoD service may be data received from the FoD server.

The processor 830 may request information related to the FoD service from the FoD server and receive information related to the vehicle FoD service from the FoD server. The processor 830 may verify an electronic signature included in the received information related to the vehicle FoD service and decrypt information for activating the FoD service included in the received information related to the vehicle FoD service. The information related to the vehicle FoD service may include the information for activating the FoD service and the electronic signature to which an encryption algorithm may be applied based on vehicle information. The vehicle information may be information on a date on which the vehicle was released.

When the verification of the electronic signature and the decryption of the information for activating the FoD service are successfully performed, the processor 830 may activate the FoD service and may transmit the result of the activated FoD service to the FoD server.

FIG. 9 is a block diagram of an FoD server according to an implementation of the present disclosure.

Referring to FIG. 9, an FoD server 900 may include a communication module 910, a memory 920, and a processor 930.

The communication module 910 may transmit and receive data to and from other elements in the FoD server 900 and external devices. The communication module 910 may be controlled by the processor 930. For example, the communication module 910 may be controlled by the processor 930 to transmit data to an in-vehicle electronic device or receive data from the in-vehicle electronic device.

The memory 920 may store data required by the FoD server 900. For example, the memory 920 may store data required for supporting a vehicle FoD service. Also, the memory 920 may store data received from a vehicle or user. For example, when the user subscribes to the FoD service, the subscription information may be stored in the memory 920.

The processor 930 may receive a request for information related to the FoD service from the vehicle and may generate information that is related to the vehicle FoD service and includes information for activating the FoD service and an electronic signature. An encryption algorithm may be applied to the information for activating the FoD service and the electronic signature based on vehicle information. The vehicle information may include information on an encryption algorithm stored in the in-vehicle electronic device. However, when the FoD server 900 is not aware of the encryption algorithm stored in the in-vehicle electronic device, the processor 930 may generate information related to the vehicle FoD service to which a plurality of encryption algorithms is applied, and the processor 930 transmit the generated information to the in-vehicle electronic device. The information related to the vehicle FoD service to which the plurality of encryption algorithms is applied may be concatenated with each other. An encryption algorithm applied to the electronic signature may differ from an encryption algorithm applied for encryption. For example, an asymmetric-key algorithm may be an encryption algorithm applied to the electronic signature, and a symmetric-key algorithm may be an encryption algorithm applied for encryption. The asymmetric-key algorithm may be RSA, the ECDSA, or a PQC algorithm, and the symmetric-key algorithm may be the AES or a PQC algorithm. The PQC algorithm may be an algorithm to which quantum computing technology is applied, and the others may be algorithms other than quantum computing technology.

In addition, the processor 930 may transmit the information related to the vehicle FoD service to the vehicle.

According to an implementation of the present disclosure, it is possible to provide a method of activating a vehicle FoD service to which an encryption algorithm is applied, and an electronic device and an FoD server to which the method is applied.

According to an implementation of the present disclosure, it is also possible to provide a method of activating a vehicle FoD service that is difficult to hack even using quantum computing technology, and an electronic device and an FoD server to which the method is applied.

According to an implementation of the present disclosure, it is also possible to provide a method of activating an FoD service for a vehicle both before and after an encryption algorithm in the vehicle is changed to an algorithm to which a quantum-resistant cipher is applied, and an electronic device and an FoD server to which the method is applied.

Effects that can be achieved in the present disclosure are not limited to those described above, and other effects which have not been described should be clearly understood from the above description by those of ordinary skill in the art.

While the present disclosure has been described above focusing on implementations thereof, it should be apparent to those having ordinary skill in the art that various modifications and applications, which have not been illustrated above can be made without departing from the fundamental characteristics and scope of the disclosure. For example, each component specified in implementations may be provided in a modified form. In addition, differences of such modifications and applications should be construed as falling within the scope of the present disclosure defined in the appended claims.

What is claimed is:

1. A method of activating a vehicle feature on demand (FoD) service by an electronic device, the method comprising:
requesting information related to an FoD service from an FoD server;
receiving information related to the FoD service for a vehicle from the FoD server;
verifying an electronic signature included in the received information related to the FoD service for the vehicle;
decrypting information for activating the FoD service included in the received information related to the FoD service for the vehicle;
activating the FoD service when the electronic signature is successfully verified and the information for activating the FoD service is successfully decrypted; and
transmitting a result of the activated FoD service to the FoD server,
wherein the information related to the FoD service for the vehicle includes the information for activating the FoD service and the electronic signature, and
wherein an encryption algorithm is applied to the information for activating the FoD service and the electronic signature based on information on the vehicle.

2. The method of claim 1, wherein the information on the vehicle is information on a date on which the vehicle is released, and
wherein when the vehicle is released after a specific date, the encryption algorithm is an algorithm to which post-quantum cryptography (PQC) is applied.

3. The method of claim 1, wherein the information on the vehicle is information on a date on which the vehicle is released, and
wherein when the vehicle is released before a specific date, a plurality of encryption algorithms is separately applied to the information for activating the FoD service and the electronic signature.

4. The method of claim 1, further comprising:
transmitting information on firmware or software applied to the vehicle in relation to the FoD service,
wherein the information on the vehicle is information on the encryption algorithm applied to the vehicle.

5. The method of claim 1, wherein an encryption algorithm applied to the information for activating the FoD service is a symmetric-key encryption algorithm, and
wherein an encryption algorithm applied to the electronic signature is an asymmetric-key encryption algorithm.

6. A method of supporting a vehicle feature on demand (FoD) service by an FoD server, the method comprising:
receiving a request for information related to an FoD service from a vehicle;
generating information that is related to the FoD service for the vehicle and includes information for activating the FoD service and an electronic signature; and
transmitting the information related to the FoD service for the vehicle to the vehicle,
wherein an encryption algorithm is applied to the information for activating the FoD service and the electronic signature based on information on the vehicle.

7. The method of claim 6, wherein the information on the vehicle is information on a date on which the vehicle is released, and
wherein when the vehicle is released after a specific date, the encryption algorithm is an algorithm to which post-quantum cryptography (PQC) is applied.

8. The method of claim 6, wherein the information on the vehicle is information on a date on which the vehicle is released, and
wherein when the vehicle is released before a specific date, a plurality of encryption algorithms is separately applied to the information for activating the FoD service and the electronic signature.

9. The method of claim 6, further comprising:
receiving information on firmware or software applied to the vehicle in relation to the FoD service from the vehicle,
wherein the information on the vehicle is information on the encryption algorithm applied to the vehicle.

10. The method of claim 6, wherein an encryption algorithm applied to the information for activating the FoD service is a symmetric-key encryption algorithm, and
wherein an encryption algorithm applied to the electronic signature is an asymmetric-key encryption algorithm.

11. An electronic device for activating a vehicle feature on demand (FoD) service, the electronic device comprising:
a communication module;
a memory; and
a processor configured to:
request information related to an FoD service from an FoD server;
receive information related to the FoD service for a vehicle from the FoD server;
verify an electronic signature included in the received information related to the FoD service for the vehicle;
decrypt information for activating the FoD service included in the received information related to the FoD service for the vehicle;
activate the FoD service when the electronic signature is successfully verified and the information for activating the FoD service is successfully decrypted; and
transmit a result of the activated FoD service to the FoD server,
wherein the information related to the FoD service for the vehicle includes the information for activating the FoD service and the electronic signature, and
wherein an encryption algorithm is applied to the information for activating the FoD service and the electronic signature based on information on the vehicle.

12. The electronic device of claim 11, wherein the information on the vehicle is information on a date on which the vehicle is released, and
wherein when the vehicle is released after a specific date, the encryption algorithm is an algorithm to which post-quantum cryptography (PQC) is applied.

13. The electronic device of claim 11, wherein the information on the vehicle is information on a date on which the vehicle is released, and
wherein when the vehicle is released before a specific date, a plurality of encryption algorithms are separately applied to the information for activating the FoD service and the electronic signature.

14. The electronic device of claim 11, wherein the processor is further configured to transmit information on firmware or software applied to the vehicle in relation to the FoD service, and
wherein the information on the vehicle is information on the encryption algorithm applied to the vehicle.

15. The electronic device of claim 11, wherein an encryption algorithm applied to the information for activating the FoD service is a symmetric-key encryption algorithm, and
wherein an encryption algorithm applied to the electronic signature is an asymmetric-key encryption algorithm.

16. A feature on demand (FoD) server for supporting a vehicle FoD service, the FoD server comprising:
a communication module;
a memory; and
a processor configured to:
receive a request for information related to an FoD service from a vehicle;
generate information that is related to the FoD service for the vehicle and includes information for activating the FoD service and an electronic signature; and
transmit the information related to the FoD service for the vehicle to the vehicle,
wherein an encryption algorithm is applied to the information for activating the FoD service and the electronic signature based on information on the vehicle.

17. The FoD server of claim 16, wherein the information on the vehicle is information on a date on which the vehicle is released, and
wherein when the vehicle is released after a specific date, the encryption algorithm is an algorithm to which post-quantum cryptography (PQC) is applied.

18. The FoD server of claim 16, wherein the information on the vehicle is information on a date on which the vehicle is released, and
wherein when the vehicle is released before a specific date, a plurality of encryption algorithms is separately applied to the information for activating the FoD service and the electronic signature.

19. The FoD server of claim 16, wherein the processor is further configured to receive information on firmware or software applied to the vehicle in relation to the FoD service from the vehicle, and
wherein the information on the vehicle is information on the encryption algorithm applied to the vehicle.

20. The FoD server of claim 16, wherein an encryption algorithm applied to the information for activating the FoD service is a symmetric-key encryption algorithm, and
wherein an encryption algorithm applied to the electronic signature is an asymmetric-key encryption algorithm.
